(19) United States
(12) Patent Application Publication
(10) Pub. No.: US 2020/0372792 A1
(43) Pub. Date: Nov. 26, 2020

(54) CROWDSOURCED REALTIME TRAFFIC IMAGES AND VIDEOS

(71) Applicant: E-Motion Inc., Sugarland, TX (US)

(72) Inventors: Larry Li, Sugarland, TX (US); Hannah Li, Sugarland, TX (US)

(73) Assignee: E-Motion Inc., Sugarland, TX (US)

(21) Appl. No.: 16/875,398

(22) Filed: May 15, 2020

Related U.S. Application Data
(60) Provisional application No. 62/852,568, filed on May 24, 2019.

(51) Int. Cl. G08G 1/01; G06K 9/00; H04W 4/44

(52) U.S. Cl. CPC G08G 1/0112; H04W 4/44; G06K 9/00832

(57) ABSTRACT

A system and method for recording videos of road views of a moving motor vehicle direction of travel, wirelessly uploading the recorded images to a remote server/cloud structure, wirelessly transmitting the recorded video images for display concurrent with the recording. The road view images can be displayed in real time. Also extracting and processing data from the images and displaying such data to a separate vehicle driver. Data may include images of other vehicles, vehicle speeds and distances, objects and object identification and road conditions including weather. Also extracting and processing data from recorded images of camera view of inside the vehicle cabin. System of incentivizing drivers to participate in the vehicle and traffic monitoring, driver performance and distraction detection, voice recognition for hands free operation, automatic vanishing point calibration, video chat/video streaming between vehicles, merchant advertising by location. There may be communication between a vehicle driver and remote monitor.

### RELATED APPLICATIONS

This disclosure claims priority to the provisional application Ser. No. 62/852,568 entitled “Crowdsourced Realtime Traffic Images and Videos” filed May 24, 2019 and which is incorporated herein by reference in its entirety.

### FIELD OF USE

This disclosure pertains to utilization of GPS correlated vehicle dash mounted smart phone cameras and video displays to upload a driver's road view of traffic and road conditions, including weather, construction, traffic accidents, etc. The video may be downloaded or streamed in real time to others, including, but not limited to drivers of vehicles that may be following the same roadway. In one embodiment, the service provides drivers of a real time, in-situ perspective of traffic conditions. In another embodiment, the service can monitor driver performance or behavior. This monitoring can include excessive lane changes, speeding, tailgating, driver distractions (texting or animated conversations with passengers), drowsiness, etc. The service can be used in conjunction with destination searches (searching for store, hotel, restaurant) and route planning. Participant drivers may earn rewards redeemable for services or products. The service can provide data for map updates, e.g., provide information regarding new roads, traffic detours including construction detours. The service can assist police, fire, EMS and other public safety agencies by providing a real time display of traffic accidents or civil disturbances.

Future transportation, including self-driving cars, required real time visual data of the roads everywhere. If real-time visual data is available for roads everywhere, drivers in traffic jams would be able to visually assess the cause of traffic jam to decide whether to reroute; digital map providers would be able to offer more frequent updated street views which are currently collected using employed drivers and vehicles at high cost; insurance companies will be better assess driver risk such as swerving and tailgating in the context of surrounding traffic and road conditions, emergency services and police can visually assess traffic accidents before arriving at the scene.

### EXISTING ART OR TECHNOLOGY

Various vehicle GPS road mapping systems and route selection services exist. Some services offer color coded updates of traffic conditions or icons signifying traffic accidents, police presence etc. Dash cameras are also offered to record traffic and road conditions encountered by a driver but they are either costly or do not support wireless communication. Some transportation districts broadcast displays of traffic conditions from elevated positions; however these roadside cameras are not everywhere, image quality is often problematic, and the images do not provide a “driver perspective” or “road view”.

### SUMMARY OF DISCLOSURE

To have cameras everywhere on the road, the invention disclosed herein takes a crowdsourcing approach by using mobile app to capture videos of the road and optionally of the driver and passengers, along with location, speed and acceleration data. The app may be free and drivers are incentivized to run the app because it enables drivers to be rewarded for the data they produce, and because the app also offers valuable services such as advanced map with navigational real-time visuals, as well as roadside assistance.

Most existing mobile apps only collect location data, often without data owner's full knowledge. Other apps collect street images infrequently and do not enable participating drivers to see real-time image/video of other drivers. Mobile apps that collect only location data cannot offer rich contextual information available in visual data. For example, knowing that there is an accident ahead is insufficient for a driver to determine whether to reroute, as the accident may involve fatality, which could take longer to clear; or minor, which would take less time. Even a stalled car may take a variable amount of time for the tow truck to arrive. Existing apps offer stale and past street views that cannot be used for real-time visual assessment, as the visual images used by these apps are collected using specially equipped vehicles that are costly to acquire and operate. Therefore the disclosure provides information to drivers superior to the maps that, for example, merely provide color coding signifying traffic congestion of the driver's preselected route. (It will be appreciated that the driver will not have any idea of the accuracy of the information, e.g., is it stale?. This disclosure provides an opportunity for the driver to obtain a real time view of the traffic conditions at multiple distances ahead of the driver's current position.)

The applicant's disclosure offers real-time collection, recording and retrieval of video, images, location and G-sensor data at owner's full knowledge and discretion. To incentivize early and wide adoption, the applicant's disclosure provides useful information extracted from the crowdsourced data back to the participants and also rewards participants for their data.

The applicant's disclosure provides services wherein real time images of actual traffic and road conditions can be shared and displayed in real time with others. This service includes participant drivers sharing real time images of their road view with other drivers.

The applicant's disclosure further creates a superior database of traffic conditions, traffic flow, areas of frequent congestion, adequacy of highway design and traffic control signally devices, etc., that will be great value to municipal planners, transportation professionals and commercial property developers, etc. This database contains recorded actual views of any selected roadway traffic conditions at any time of day or for any duration of days or weeks.

With properly positioned mobile phone, the applicant's disclosure also provides services wherein real-time images of driver and road together can be used to automatically assessed driver attention level and drive performance. The assessment can be shared with driver's permission with auto insurance companies for the purpose of premium calculation.

### SUMMARY OF DRAWING

The accompanying drawings, which are incorporated in and constitute a part of the specification, illustrate preferred embodiments of the invention. These drawings, together with the general description of the invention given above and the detailed description of the preferred embodiments given below, serve to explain the principles of the invention.

FIG. 1 provides a system overview showing multiple “crowdsourcing” data input from multiple drivers, data sharing via a cloud or server infrastructure and other entities utilizing the driver data.

FIG. 1A illustrates multiple vehicles utilizing the app wherein each will display a differing “front view” and certain vehicles are behind other vehicles traveling in the same direction.

FIG. 1B illustrates multiple vehicles utilizing the app wherein the illustrated roadway has multiple traffic lanes all oriented in the same direction.

FIG. 1C illustrates two multiple lane divide highway overpass showing multiple vehicles participating in the app.

FIG. 1D illustrates three vehicles in a single traffic lane where one participating vehicle is trailing a lead vehicle at a distance. The lead vehicle is following a third and non-participating vehicle. Illustrated is information displayed to the following vehicle.

FIG. 1E illustrates a forward view displayed by a participating driver. The displayed information may include optional “bounded boxes” information generated by artificial intelligence (Al) and algorithms of the disclosure.

FIG. 2 illustrates an embodiment of client (driver) application top-level subsystems.

FIG. 3 illustrates an embodiment of the client application sensor data collection and reporting that may be performed by a smartphone utilizing the application.

FIG. 4 illustrates an embodiment of display feature, camera views and data utilization. Included is data processing and image display for the driver as well as video streaming and wireless communication for image sharing.

FIG. 5 illustrates still image processing.

FIG. 6 illustrates the driver's “road view”, i.e., front facing image processing including examples of data analysis such as tailgating detection, etc.

FIGS. 7 and 8 illustrate examples of car distance estimation and tailgating detection.

FIGS. 9 and 10 illustrate data analysis used in lane departure detection and road sign detection.

FIG. 11 illustrates data analysis of vehicle interior view, i.e., “cabin-facing image detection”.

FIG. 12 illustrates a detail of driver and passenger face isolation for facial recognition and monitoring of behavior or emotion.

FIGS. 13, 14, 15, and 16 illustrate different functions of facial recognition, including analysis of facial characteristics to determine driver distraction.

FIG. 17 illustrates the dashboard positioning of a smartphone display in landscape and portrait orientations for optimal data collection, including alignment with horizon and vanishing point defined by the converging perspective lines.

FIG. 18 illustrates an embodiment for connecting and disconnecting from a cloud/server infrastructure utilizing the smartphone application of this disclosure.

FIG. 19 illustrates an embodiment of the application control for performing functions of the application on the smartphone.

FIG. 20 illustrates an embodiment for a participant to obtain a driver video, e.g., showing a road view.

FIG. 21 illustrates an embodiment of the disclosure for participant and driver communication, e.g., video chat.

FIGS. 22 through 24 illustrate an embodiment for determining a “horizon” or dynamic vanishing point.

### DETAILED DESCRIPTION OF DISCLOSURE

The disclosure includes a system of multiple motor vehicle drivers participating or individually utilizing the smartphone (or similar device) application wherein the application allows a plurality of participants to individually record and upload video images of motor vehicle operation (particularly “road views”) for sharing with others. A participant driver can receive real time or recently recorded video displays of traffic and road conditions, including but not limited to weather, road construction, traffic accidents, etc., pertaining to multiple locations. The participant can select among displays having the best quality. The participant can select among the most recent displays having the greatest relevance to the participant's location and intended travel route. The participant can select among displays showing alternate routes. Such alternate routes may be created by the software subject of this disclosure. The alternate routes may be created in response to a request from a participant driver observing the received image.

The video displays are individually sourced from multiple participant drivers. The participating recipient driver (or other entity such as insurance company, emergency response teams or the like) can select from multiple images being recorded and displayed from multiple locations. It will be appreciated that the images are available for remote display in real time, i.e., within the time that the events subject of the images are happening, i.e., virtually immediately.

This system has innumerable uses as will be described herein.

The disclosure utilizes “crowd sourcing” techniques to create a valuable data base for use by others. One group of beneficiaries of this crowd sourced database is other drivers; another group is insurance companies that can benefit from having driver behavior data to better assess risks; yet another is product and services companies wishing to attract drivers. The disclosure also includes alerting participating “following” drivers of approaching vendor establishments such as restaurants. The images could include vendor signs. Also the disclosure includes the reading of QR codes that may be contained in the signs and display of the coded information.

Another portion of this disclosure is a method for rewarding drivers for collecting and sharing videos, images and data from vehicle operation. Participant drivers, i.e., drivers that are recording their travel, may receive compensation. The compensation could be money, points or credits received by the participant driver based upon the duration of the video uploads contributed to the database. The compensation can be based upon number of participant viewers. The compensation could be based upon the duration of a single participant viewer watching the video. The compensation could be dependent upon the number of “likes” received from viewers. Note that a favorable drive view could be a steady view without frequent lane changes or too closely following another vehicle. This could encourage/compensate safe driving habits.

The compensation could also be based upon the relevancy of the participant's driver's route. For example, a drive through a low traffic density area (country road) would perhaps not be as valuable as travel on a principal roadway or in the vicinity of frequent traffic congestion.

In another example livery drivers, e.g., Uber or Lyft driver's may supplement income by recording and live streaming their travel routes utilizing participation in the application. Uber is a trademark of Uber Technologies. Lyft® is a trademark of Lyft, Inc.

In another embodiment, the ability to provide “in cabin” monitoring and recording where legally allowed, and with user permission, may offer added security to both passengers and drivers.

Participant's viewing uploaded video could pay compensation for this access.

Compensation could be paid per-use, or on a subscription basis. In another embodiment, the compensation could be based on the duration of the video downloaded. This fee could be charged to an account established with the database service provider.

In yet another embodiment, the participant driver (uploading videos) could receive credit redeemable for the duration of videos separately downloaded. Stated differently, the participant driver could be both a supplier of uploaded motor vehicle operation video for the database and separately a consumer of information from the database.

In yet another embodiment, driver's supplying uploaded video could receive credit against past traffic violations. Supplying relevant data regarding traffic conditions may be viewed as a form of community service. Further, it would allow monitoring of the past offender's motor vehicle operation by public safety entities. It would address a relevant question of whether the past offender has “learned his/her lesson”. Providing video of vehicle operation could be a condition of retaining driving privileges

The application requires a system of servers working together to achieve the desired function, i.e., the creation and maintenance of current and geographically correlated videos of traffic and road conditions from each participating driver, business partners and data customers.

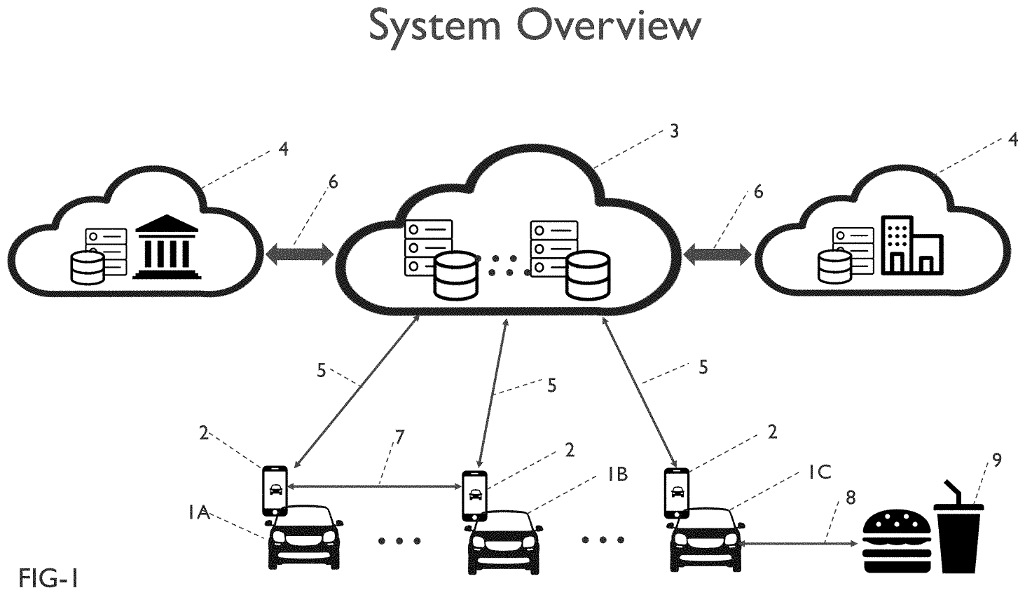

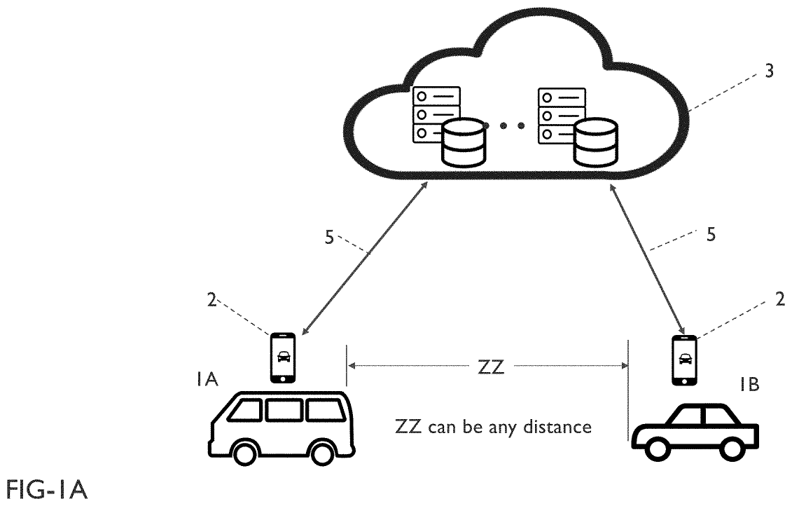

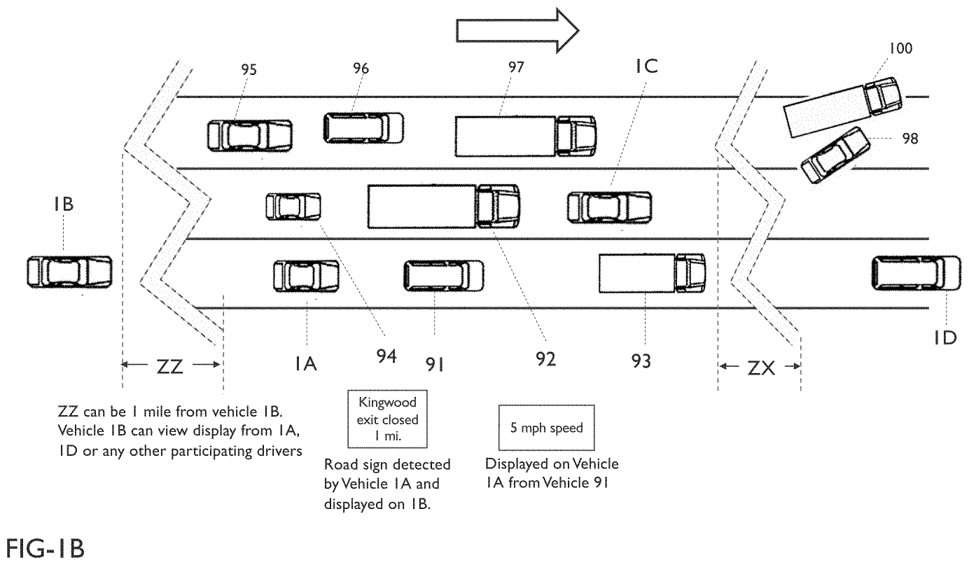

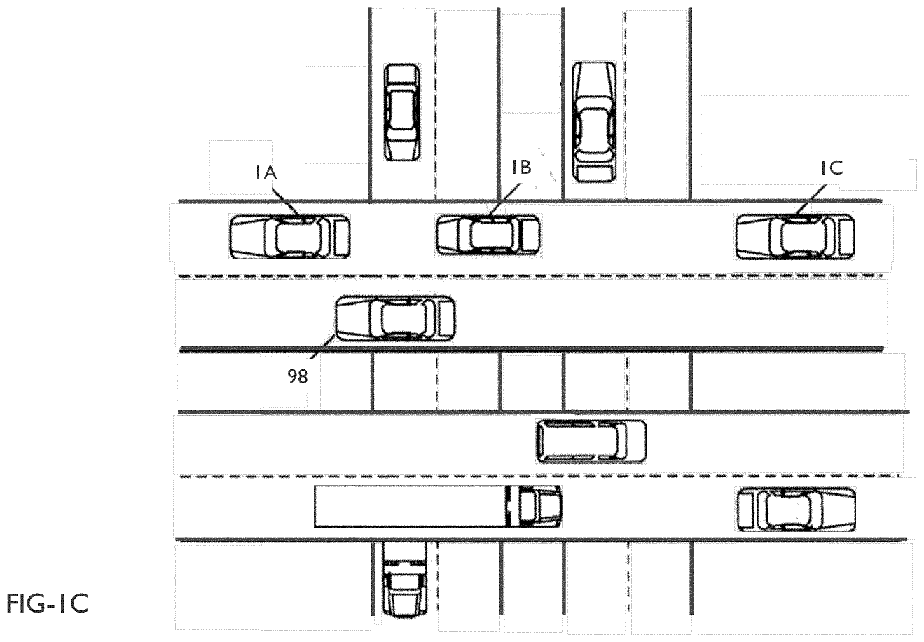

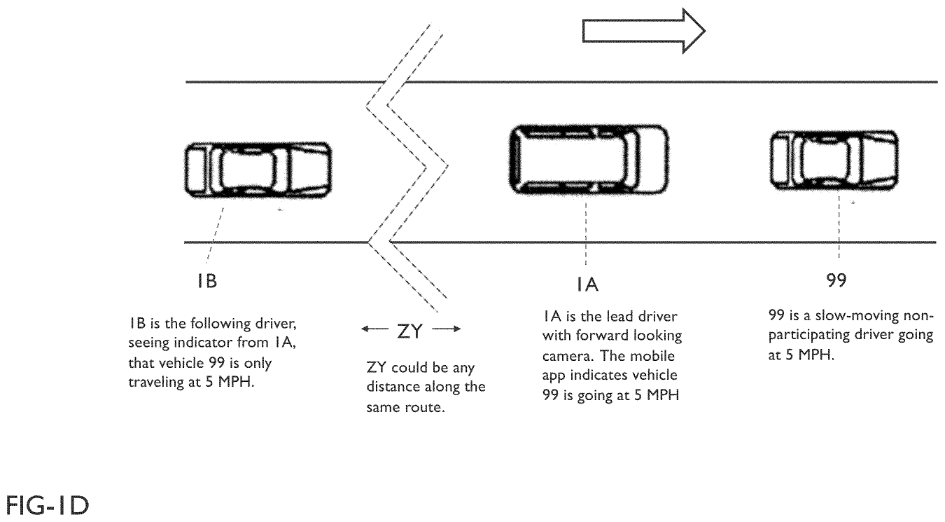

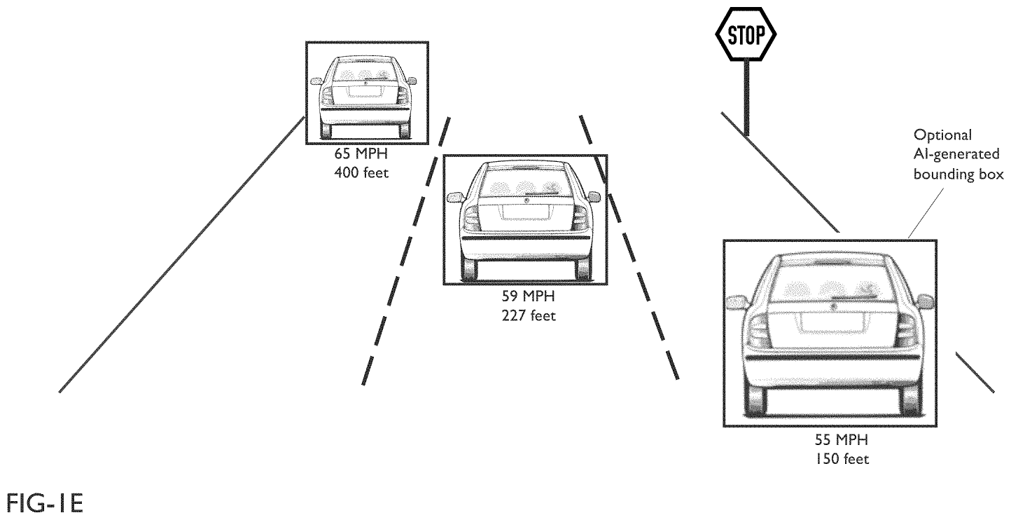

Referencing FIG. 1, the system consists of a collection of drivers 1A, 1B, 1C each running the client app 2 on their mobile phones. These may be referred to as “participating drivers” or “participating vehicles”. It will be appreciated that one driver's camera video may be displayed on a second driver's smart phones utilizing streaming protocols 7 such as WebRTC. As discussed further, the smart phones may be detachably mounted to the vehicle dashboard. It will be appreciated that other functions of the smart phone are not impeded by use in this disclosure. In alternate embodiments, the camera could be supplied or incorporated into the vehicle. The client app 2 may communicate with the operator of servers or cloud infrastructure 3 over the cellular wireless network 5. The operator server/cloud infrastructure 3 may include one or more servers and data storage components, and is capable of cloud to cloud communication 6 with other customer cloud infrastructure 4. The client app 2 is also capable of communicating with nearby stores 9 such as a fast food restaurant, using near field communication 8 such as Bluetooth/BLE or NFC available on most modern smartphones.

The top-level components of the system are described below:

Driver 1A, (or driver 1B, 1C, etc.) is the one owning the smartphone running the client app 2. Registration with the database operator is required for the driver to obtain an account in the operator server/cloud infrastructure 3. Possessing an account will allow the driver 1A to upload video of his/her road view recorded from a dash mounted smartphone. Registration will include mechanisms for accounting and crediting driver 1A for the video image. The video can be ranked by location relevancy, duration, etc.

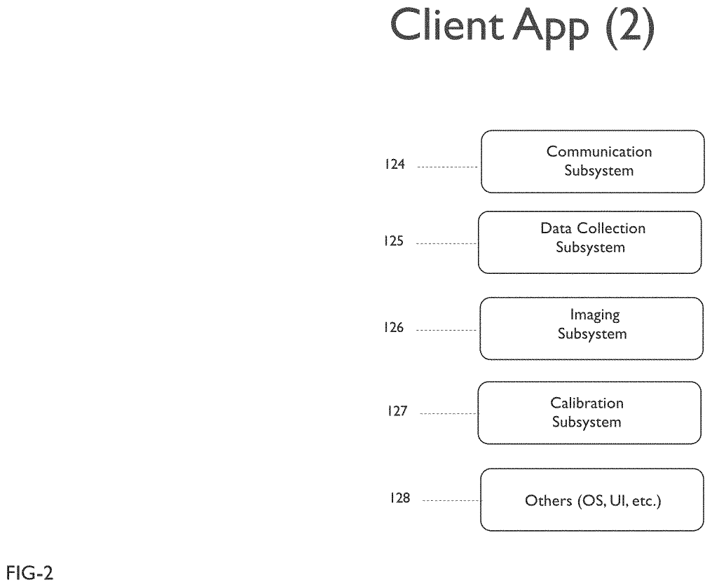

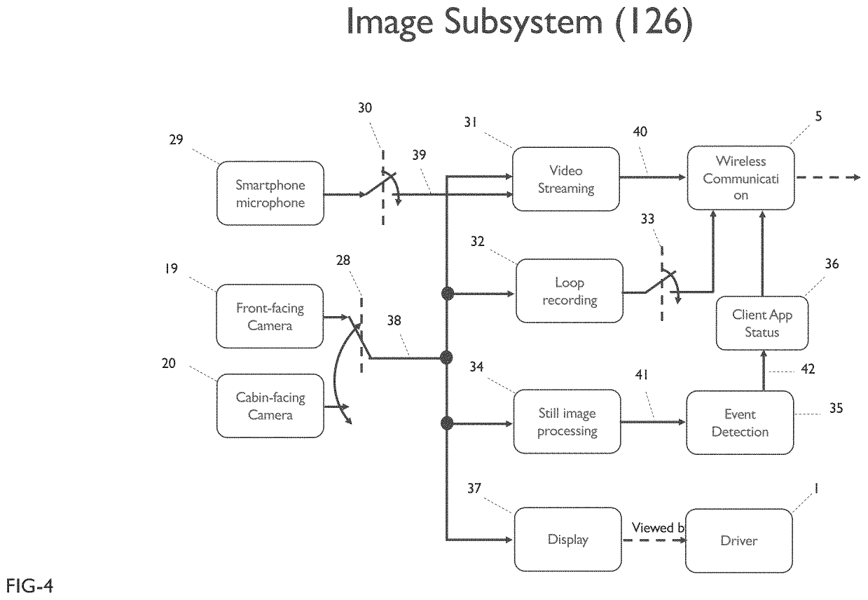

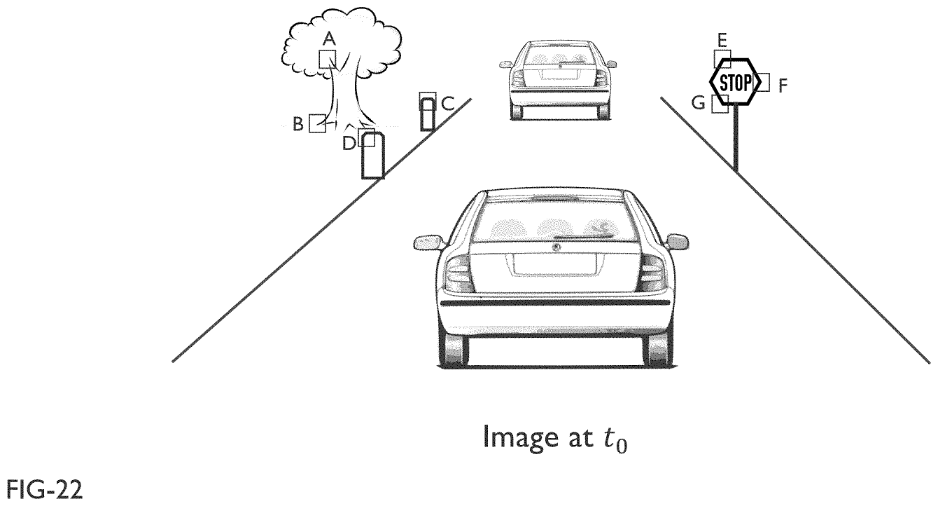

Turning to FIG. 2, the Client App 2 has many software components. The key top-level components are the image subsystem 126, responsible for process images collected from either the front-facing camera 19 or the cabin-facing camera 20. Reference is made to FIG. 4 discussed infra. The communication subsystem 124 is responsible for communicating over the Internet to the operator server/cloud infrastructure 3. The communication subsystem also communicates with the data collection subsystem 125, the calibration subsystem 127, and other system services 128, such as operating system, user interface, etc. The data collection subsystem 125 collects sensor data; and calibration subsystem 127 performs view port setup, and vanishing point and horizon calibration. Reference is made to FIGS. 22 through 24.

Returning to FIG. 1, the server/operator cloud infrastructure 3 includes servers and storage of the operator owning the client app and containing the uploaded database. The infrastructure is capable of communicating with client app 2 and inter-cloud communication 6 with other customer apps and cloud infrastructure 4. The business logic running in the servers include user account management, data management, crowd-source data analytics, peer-to-peer video chat connection, and secure digital marketplace where participant drivers 1A, or driver 1B, 1C, etc. (suppliers of uploaded video) and customers can trade, sell and buy data. It will be appreciated that the customers include participant drivers (also owning the client app 2) that download road view videos for route planning, etc. Live video chat feature is depicted as a two-way vector arrow 5 discussed infra.

Customer cloud infrastructure 4 includes servers and data storage of the customers wishing to buy data from the operator 3 or participate in the secure digital marketplace. This communication path between customer cloud infrastructure 4 and the database operator 3 is shown by the vector arrow 6.

Communication between drivers 1A, or driver 1B, 1C, etc. and the database operator 3 is achieved through cellular data or Wi-Fi communication 5 on the Internet.

Inter-cloud communication 6 may comprise hardline, cellular or Wi-Fi communication on the Internet between operator cloud infrastructure 3 and customer cloud infrastructure 4

Peer-to-peer communication 7 may be direct wireless peer-to-peer communication between two drivers 1A, 1B over protocols such as WebRTC. Usually for two drivers in separate local area networks to communicate directly, they must know each other's Internet address. Since the operator cloud infrastructure 3 can see both drivers' Internet address, it can exchange the Internet addresses to establish peer-to-peer connection 5. Driver anonymity is maintained.

Near-range wireless communication 8 is Bluetooth or Bluetooth Low-Energy BLE Near Field Communication NFC or other near -range communication commonly found on smartphones. The signal strength (RSSI) can be used to detect proximity of other network participants, and data encryption is used to exchange information securely, including financial information.

Commercial establishments 9 may be registered with the operator 3 and may detect presence of nearby drivers and push advertisements to them over wireless network 5. Drivers near the stores may purchase goods and services, or food and beverages, by obtaining the necessary store information through the wireless network 5 or the near-range communication 8. Drivers may pre-order services or items for pickup.

FIG. 1A illustrates that participating vehicle 1B is following participating vehicle 1A. The distance ZZ between the vehicles can vary. The vehicles can communicate via cell phone signals 5 communicating with a server. The server may be located in the cloud 3.

FIG. 1B illustrates a particular advantage of the disclosure. Following vehicle 113 is traveling a distance ZZ behind participating driver 1A. The front view transmitted by vehicle 1A to vehicle 1B shows a traffic jam. Switching to the view transmitted by participating vehicle 1C may show the lane ahead is substantially clear of traffic. This switching of views may be accomplished using a touch screen or verbal command “next driver on route” or “show view ½ mile ahead”. Further, switching to the view transmitted by participating vehicle 1D may further inform the driver of trailing vehicle 1B that the highway speed has resumed to 65 mph. The distances ZZ, ZX existing between vehicle 1B and vehicle 1D can be displayed to driver 1B.

Further, FIG. 1B illustrates that vehicle 1B receives notice via the display from vehicle 1A that the vehicle's 1B exit is closed, and therefore the driver of 1 may want to try and re-route. Further, the combined displays may inform the driver of vehicle 1B that the traffic jam is caused by an obstruction of the left lane 97, 98, 100 but that traffic continues to move, albeit at a reduced speed, in the right lane 91, 93. Therefore the driver 1B may want to maneuver to the right lane. It will be appreciated that none of this information would be accessible without the teaching of this disclosure. Further, color coding of traffic routes would not distinguish between the location of the specific obstruction and the advisability of maneuvering to a specific traffic lane.

FIG. 1C illustrates the selection of participating drivers proximate to a highway intersection. This selection can be achieved using voice commands to minimize the driver's distraction from viewing the road ahead. When initiating the application, the driver of vehicle 1C may see multiple participating vehicles. However only vehicles 1A, 1B may be relevant to the driver of vehicle 1B since only those vehicles are ahead and traveling in the same direction.

FIG. 1D illustrates another embodiment of the applicant's disclosure. The driver of vehicle 1 is receiving the front view camera display from vehicle 1A. Vehicle 1B is a distance ZY behind vehicle 1A. The transmitted front-oriented display from vehicle 1A discloses that the vehicle 99 immediately in front of vehicle 1A is only traveling at 5 mph. Therefore driver of vehicle 1B knows that there is some obstruction in the traffic lane ahead and that speed should be reduced. Note this information is accessed without the driver of vehicle 1B seeing the activation of vehicle 1A's brake lights. Recall that the driver of vehicle 1B can summon the information displayed from vehicle 1A by voice command to the app. For example, requesting “display from nearest ahead driver” may display view from a vehicle 5 cars ahead of vehicle 1B or 20 cars ahead, depending upon the location of the next participating vehicle.

FIG. 1E illustrates the information that can be disclosed via display of the front-oriented (road view) camera of a participating vehicle in one embodiment of the disclosure. Illustrated is the speed and distance ahead of three separate vehicles. It will be appreciated that the speed and distance information may be shown in bounded boxes that are readily visible to the person viewing the display. In other embodiments, the information can be highlighted with color. Note further that the AI of the disclosure can identify traffic signs, such as a stop sign or a speed limit sign, which when combined with speed detection, can be used to determine if the driver is obeying the traffic sign. This disclosure's AI detection or determination of the nature of the sign may precede the driver's perception. This will be appreciated to be another safety feature. In another embodiment, the AI can provide forward collision warning by detecting when the vehicle ahead is too close, or when an adjacent vehicle is weaving into the driver's lane, and further caution is warranted.

Returning to FIG. 2, the relationship between Client App 2 components are described below.

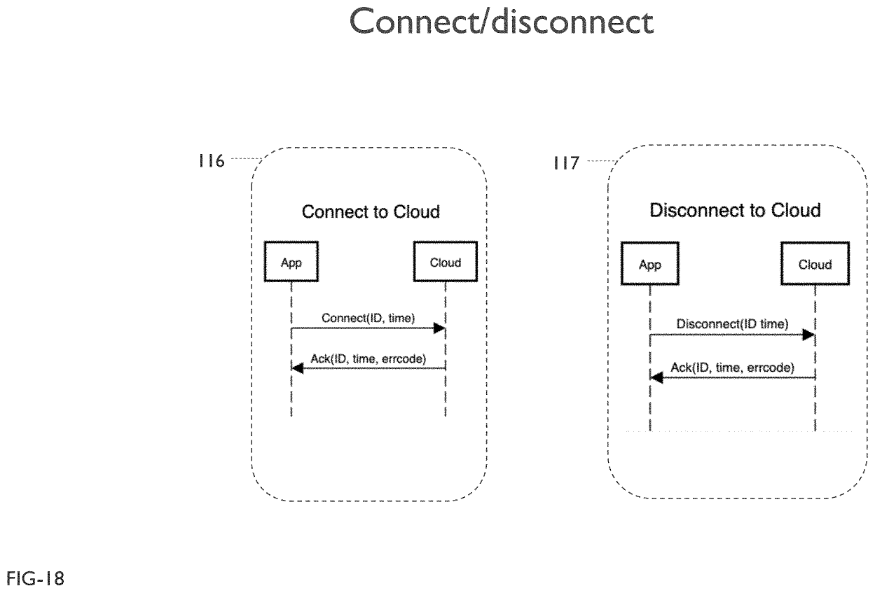

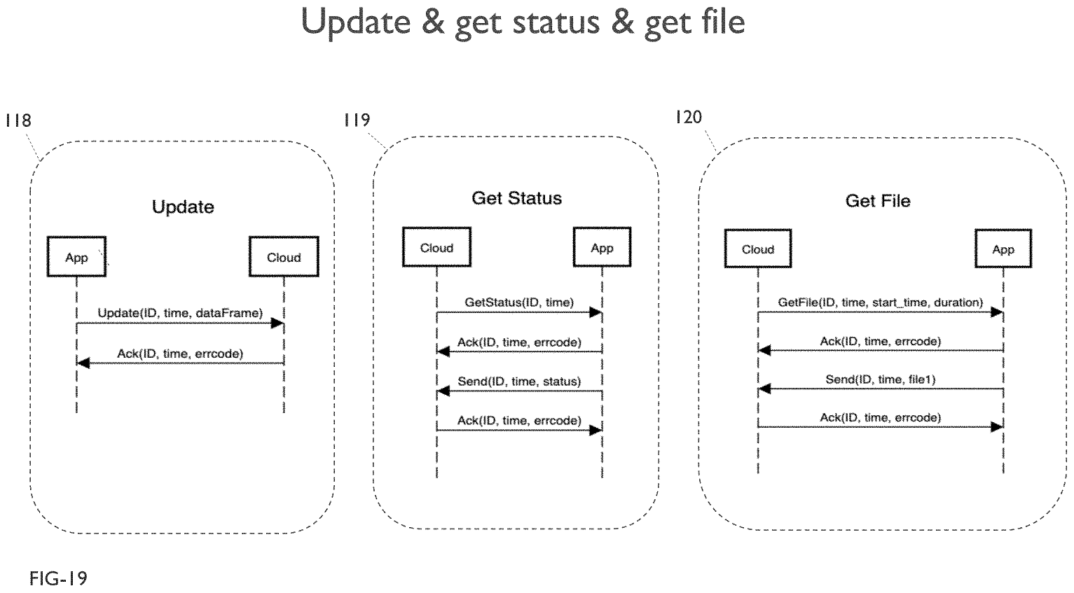

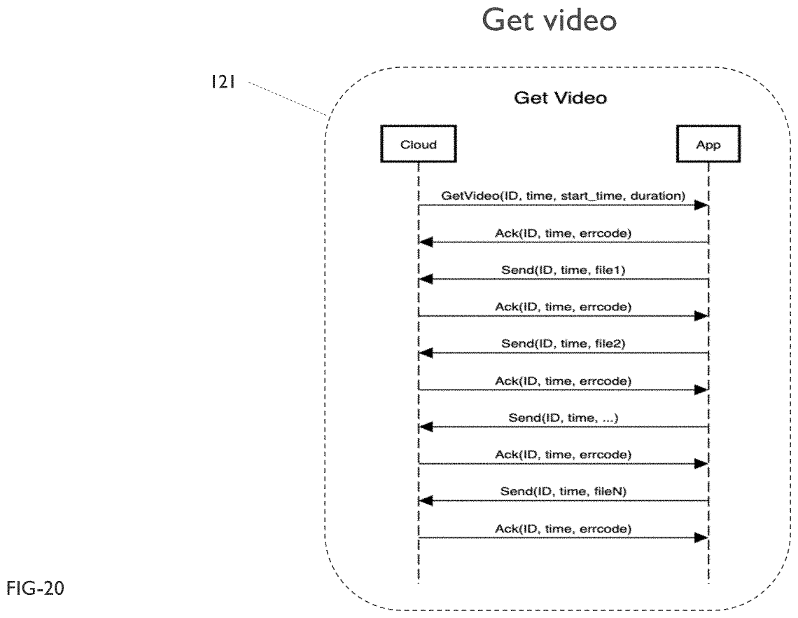

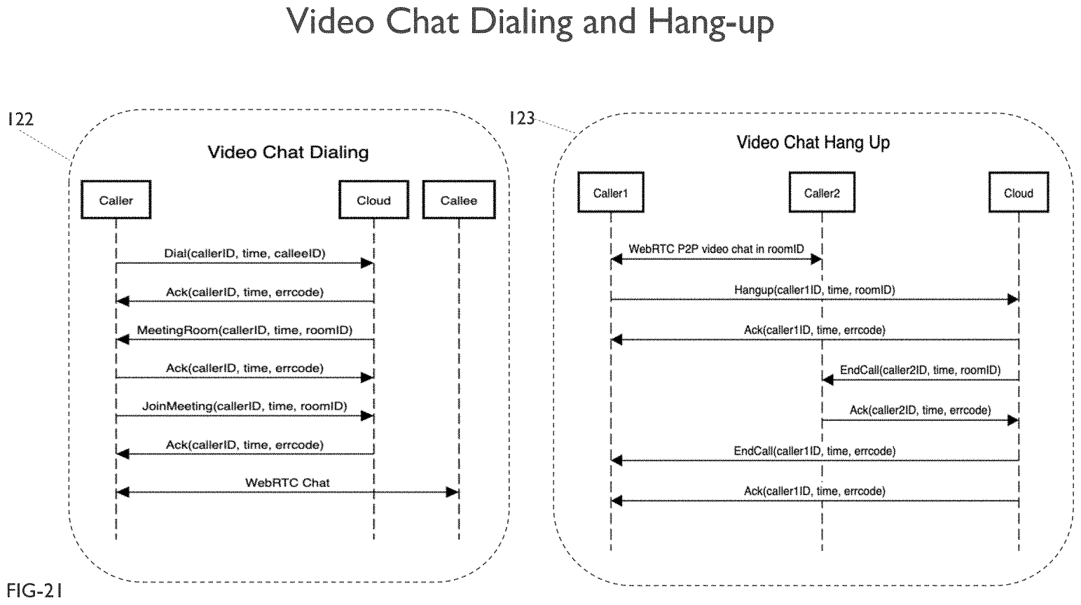

Communication Subsystem 124 handles communication with other devices and servers, mostly over Wi-Fi or cellular wireless network 5. The communication subsystem 124 supports application functions such as connect to and disconnect from operator cloud infrastructure 3 shown in FIG. 18, as well as update, get status and get file operation as shown in FIG. 19, get video operation as shown in FIG. 20, and video chat dialing and hang-up shown in FIG. 21.

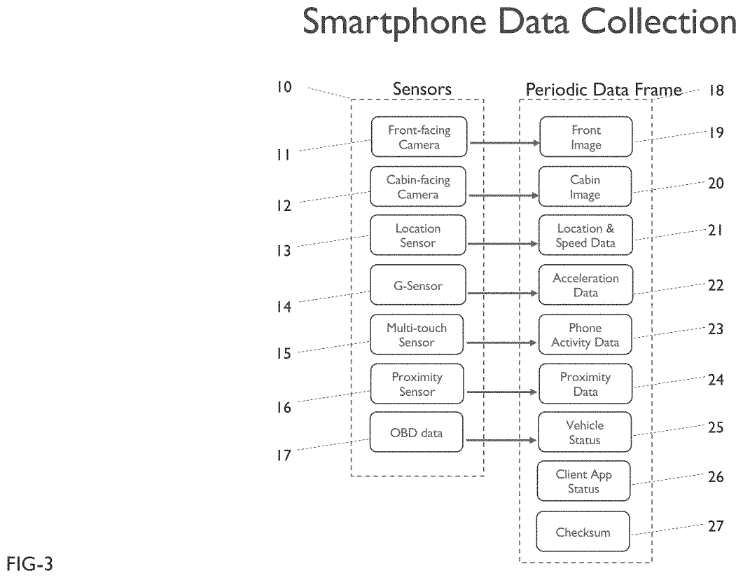

Data Collection Subsystem 125 pertains to the components shown in FIG. 3. The smartphone embodies commonly available sensors 10, including front-facing (road view) camera 11, cabin-facing camera (back-facing camera) 12, location sensor, such as GPS 13, G-sensor 14, multitouch sensor, part of the touch screen 15, and proximity sensor, part of Bluetooth/BLE or NFC 16. The components of the smartphone can monitor, record and transmit information regarding vehicle operation such as speed, acceleration, braking, turning, etc. If an OBD device is available inside the car, OBD data 17 can be collected over Bluetooth or Wi-Fi to be included in the Sensor data 10. The OBD device can also provide vehicle operation data.

These sensors are periodically collected by the client app 2 to form a data frame 18 that is periodically reported to the operator cloud 3 over cellular wireless network 5, typically at a frequency of 1 Hz. The data frame 18 includes Front image 19 collected from the Front-facing camera 11, Cabin image 20 collected from Cabin facing camera 12, depth image, location and speed data 21 collection from the location sensor 13, acceleration data 22 collected from G-sensor 14, phone activity (touch screen activity or voice command) data 23 collected from Multi-touch sensor 15, proximity data 24 collected from proximity sensor 16, and vehicle status 25 extracted from the OBD data 17. The data frame 18 also includes client app status 26 and checksum 27 to ensure communication integrity. Reference is made to FIG. 3.

Imaging subsystem 126 depicted in FIG. 2 supports video and image processing of the front-facing camera 19 and cabin-facing camera 20, selectable by a software camera switch signal 28. Reference is made to FIG. 4. The video stream 38 is packetized by the Video Streaming block 31 into Real-Time Streaming Protocol (RTSP) format or equivalent 40 to be delivered through internet over the wireless communication 5. Audio 39 from the smartphone microphone 29 may be included in the stream if mute 30 is de-selected. The video stream 38 is also loop recorded 32 in the local smartphone storage, which can be retrieved 33 over the wireless communication 5. The video stream 38 can be captured frame-by-frame and processed by the still image processing block 34 to detect meaningful events 35. Detected events 42 are registered in the Client app status 36 in the Periodic Data Frame 18 sent to the operator cloud infrastructure 3. The video stream is also sent to this smartphone display 37 viewable by the driver. See FIG. 4.

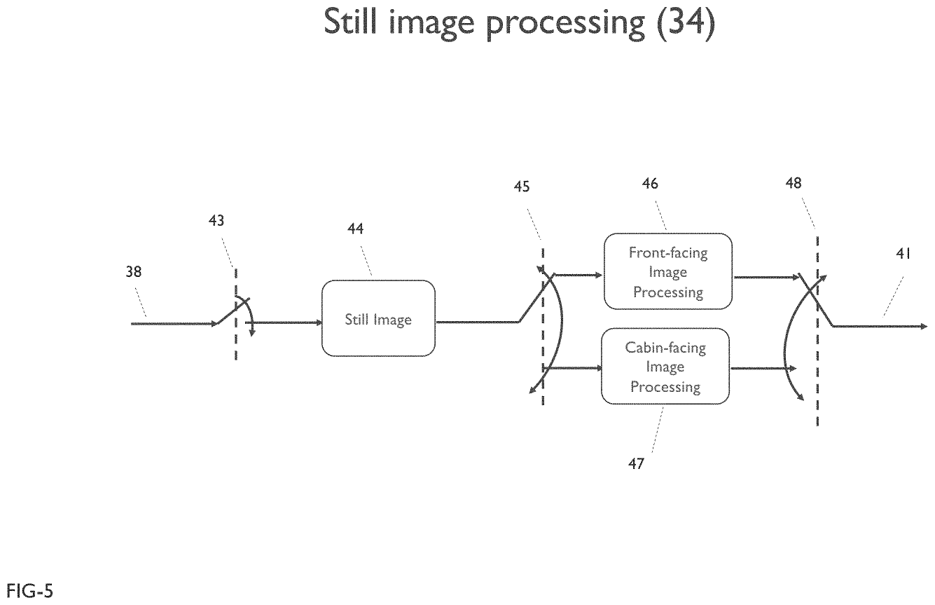

In an embodiment, a driver may request information regarding a location; but there may be no participating driver currently at that location. The disclosure can ascertain and identify a participating driver that has recently passed through the location and request earlier recorded video of the location from the participating driver's app 2. See FIG. 4. Alternatively, the disclosure can download from the server 3 still image 44 (See FIG. 5) of the location previously uploaded by other participating driver.

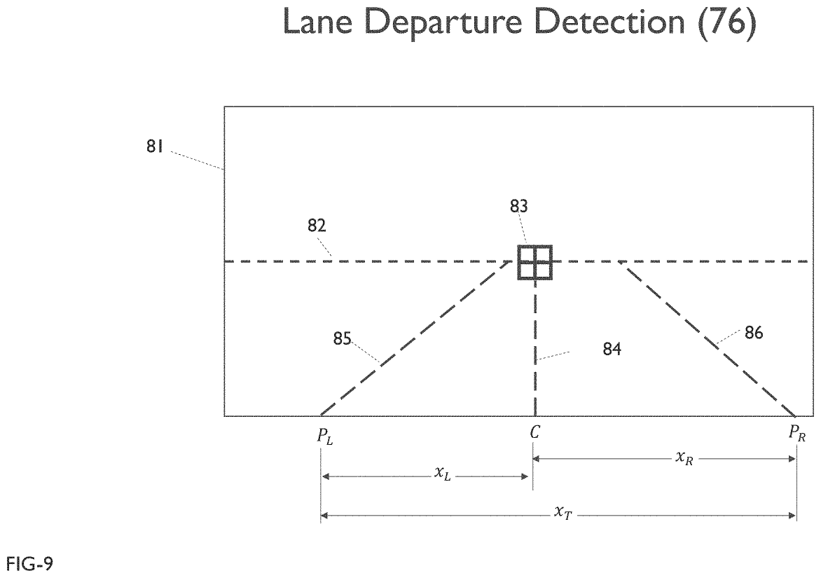

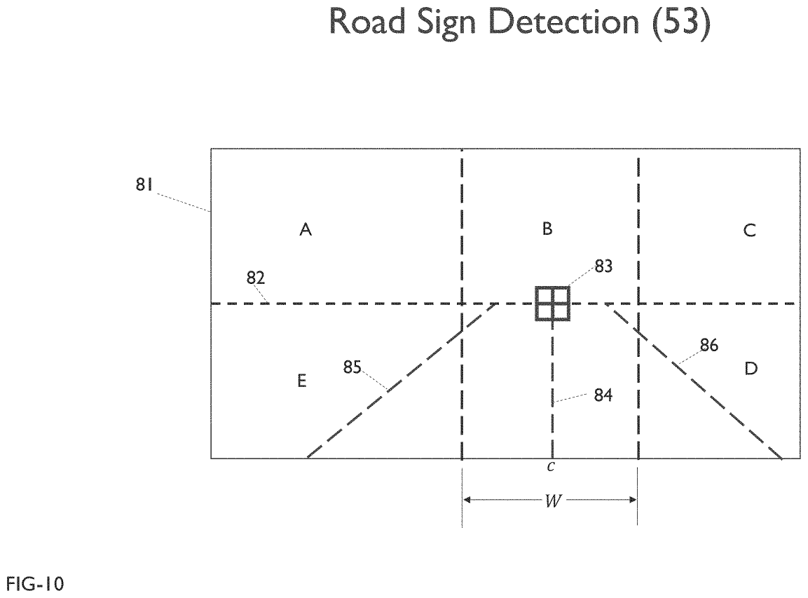

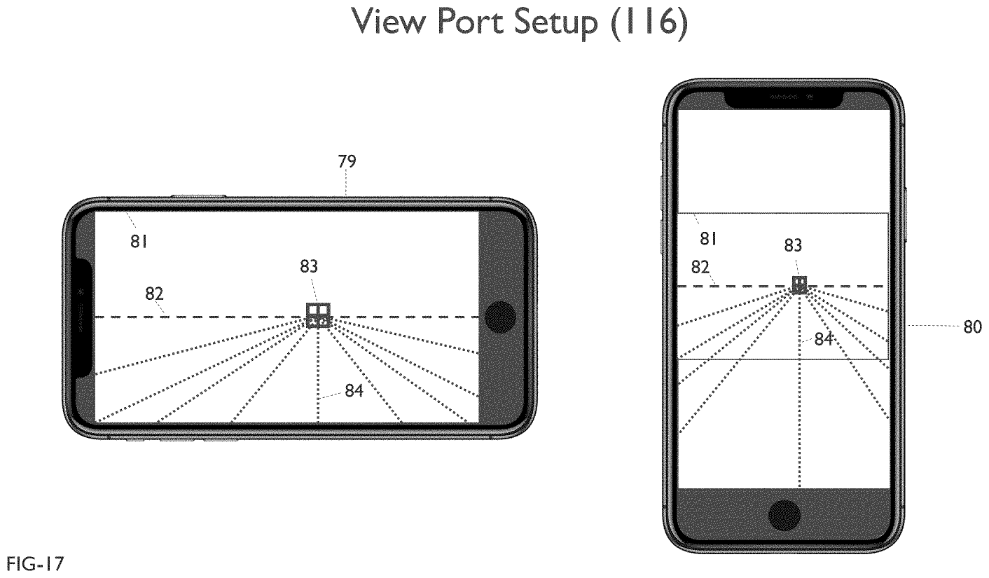

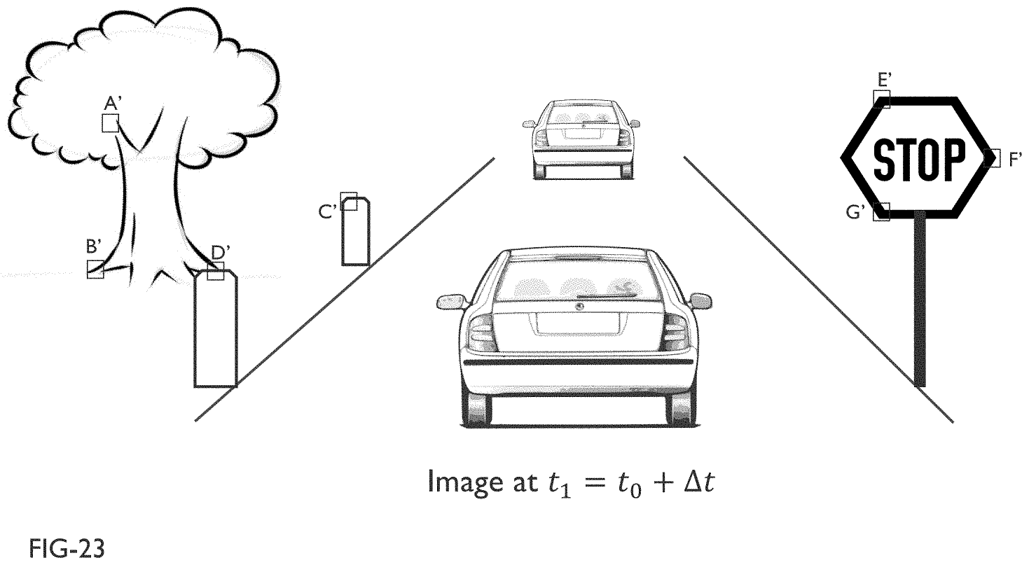

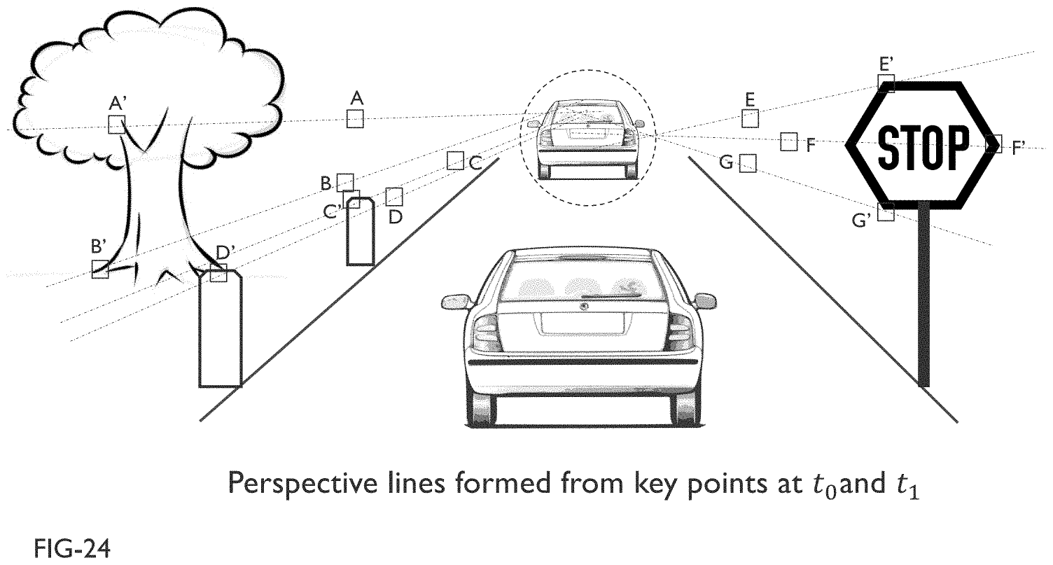

The calibration subsystem 127 (FIG. 2) handles manual and dynamic calibration of the vanishing point 83 depicted in FIGS. 9 and 10. The View Port setup 116 (FIG. 17) shows manual calibration of the Vanishing Point 83. Referring to FIG. 22, dynamic vanishing point calibration can be deployed as well and is included within the scope of this disclosure. An example of dynamic vanishing point calibration, shown in FIG. 22-24, can utilize recorded movement of images as the vehicle drives. A first image of objects fixed to the ground is collected a t₀ (FIG. 22) and a second image is collected at t₁ (FIG. 23). Key points A-G in the first image are tracked in the second image (A′-G′). The lines connecting the same key point in the first frame and in the second frame forms a perspective line (FIG. 24). Key points in each image can be extracted using Scale Invariant Feature Transform (SIFT) operator or equivalent. Alternatively, the Optical Flow algorithm that follows a similar approach, could be used. It is appreciated that the perspective lines resulted from this algorithm will point towards the vanishing point.

Subcomponents of Image Subsystem 126 (FIG. 4) is described below:

The job of the video streaming function 31 is to encode the raw camera video stream into packet transport 40 such as RTSP, suitable for transmission of IP network 5

The purpose of loop recording 32 is to record the raw camera video 38 into compressed MP4 file suitable for file storage. This will save space and expense of storing the images in a separate server or cloud storage. The video recording is also evidence for defending against potential frivolous lawsuits and traffic disputes.

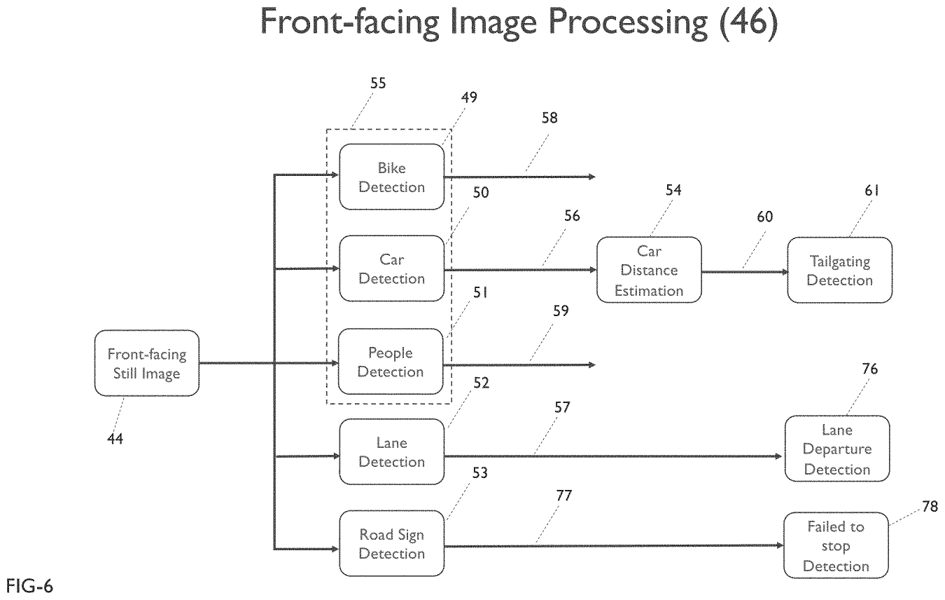

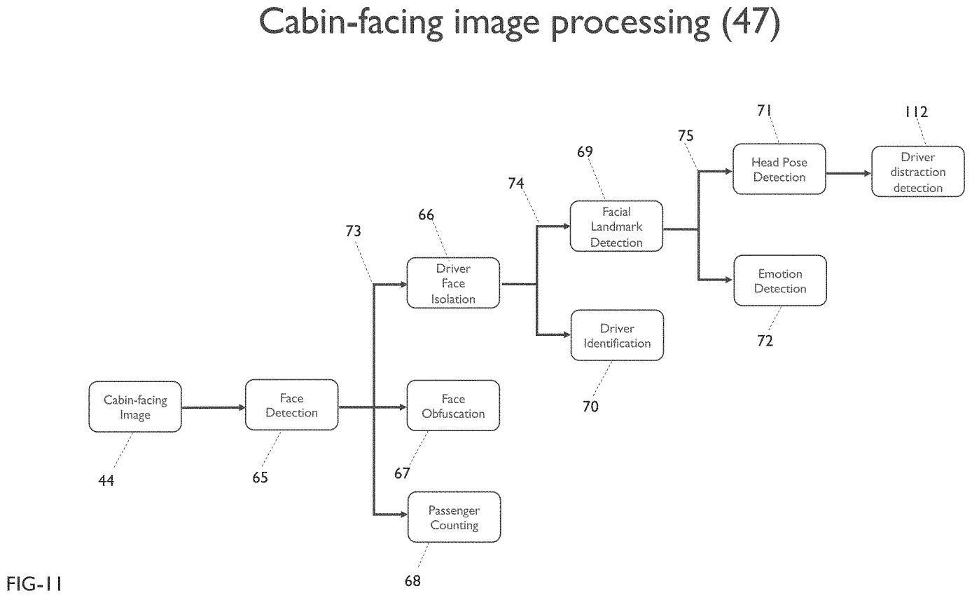

Referencing FIG. 5, the still image processing 34 starts by sampling 43 the video stream 38 at a rate sufficient for the still image processing 34 to complete. Sampling of a video stream 43 results in a still image 44, which is then transmitted to either front-facing image processing block 46 (FIG. 6) or cabin-facing image processing 47 (FIG. 11).

Referencing FIG. 5 again, the software video switching signal 45 and 48 determine whether front-facing image processing 46 or cabin-facing image processing 47 is done. The video switch signal 28, 45, 48 are one and the same. The output of the still image processing 34 is a set of features useful for determining presence of certain meaningful events 41.

To ensure anonymity, participating driver 1A, sharing his/her road view, can elect that a cabin view will not be shared. For example, if driver 1A switch to cabin view, driver 1B will only see a blank screen. Alternatively, if front camera view is being shared, the video switch may be disabled for the duration of the front view sharing.

Returning to FIG. 4, the purpose of Display 37 is to show the unedited camera view on the smart phone display viewable by the driver 1. As unedited, the display from the camera view may not show the data enhancements provided by the artificial intelligence (AI) of the disclosure and described more fully below. In another embodiment, AI enhancement may appear as an overlay to the unedited image.

Subcomponents of Still Image Processing 34 (FIG. 5) are described below:

Still Image 44 is a sampled image from the raw camera video 38.

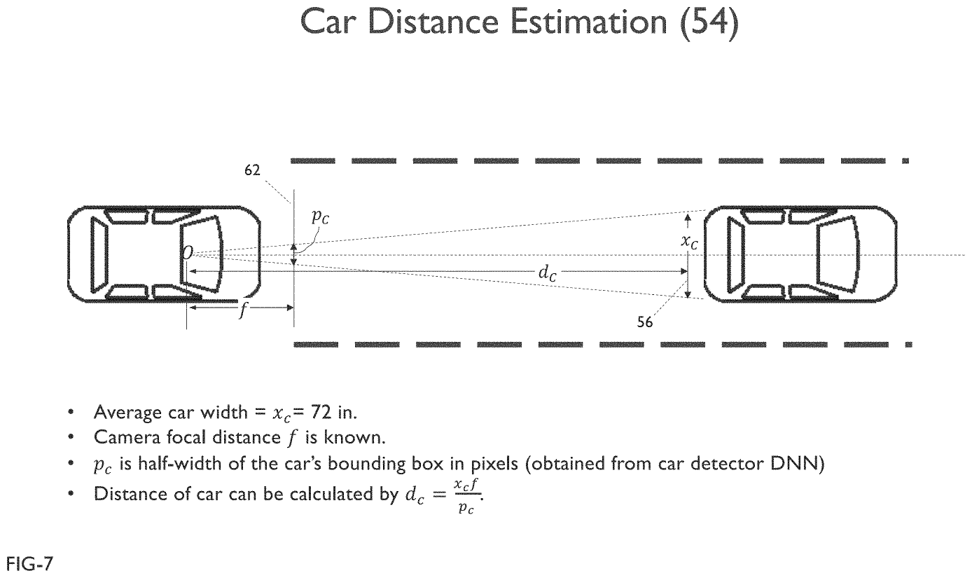

Referencing FIG. 6, front-facing image processing 46 includes bike detection 49, Car detection 50, People detection 51, lane detection 52 and road sign detection 53. The first three detectors 49-51 could be implemented by a deep neural network (DNN) 55, such as You-Look-Only-Once (YOLO) network. The disclosure is not, however, limited to only this approach. In other embodiments, the disclosure may utilize databases containing numerous image views. The disclosure may utilize machine learning to correlate the object image to images contained in the database. Road sign detection 53 also can be implemented by a different DNN model or variation of machine learning algorithms. Lane detection algorithm is generally implemented using a robust form of edge detection algorithms. Bike detection 49, car detection 50 and people detection 51 all produce bounding boxes surrounding the object of interest as output 58, 56, 59. The car bounding box 56 in particular is useful for car distance estimation 54 and vehicle speed. See FIG. 7. As discussed elsewhere, it will be appreciated that the bounding boxes make the information quickly accessible to a driver viewing the display. This minimizes the time the driver needs to view the display versus viewing the traffic via the windshield. The disclosure also includes an embodiment wherein verbal announcement is made to the driver such as “bicycle ahead” or “stop sign”.

The speed of a vehicle appearing in the driver's front facing image can be calculated from changes in the distance separating the vehicles over time. Distance between vehicles is disclosed in FIG. 7 discussed below. The driver may receive an alert via sound or display if determined to be following too closely.

Front facing still images 44 can be used by Lane Detection 52 to find lane lines 57, which can be used to detect lane departure 76. The still images 44 can also be used to detect road signs 53; the type of sign 77, can be used to determine driver compliance, such as if the driver failed to stop at a stop sign 78.

In another embodiment, the following driver 1B can use the front view (camera view) of the lead driver 1A to assist safe driving at night or foggy/rainy weather. The 1A driver's image will display upcoming road signs that are not visible to 1B driver. For instance, the 1B driver may obtain advance warning of an upcoming stop sign. The disclosure thereby increases the 1B driver's field of vision (or effective distance of vision). Note further that this enhanced field of vision can facilitate driving safety when driver 1B is located behind a large tractor trailer or similar vehicle that dramatically blocks the driver's view of the road and traffic ahead.

The received image is also manipulated by the application to show the speed of the driver 1A and distance between driver 1A and the vehicle ahead. Also the image shows if there are other vehicles occupying adjoining lanes. (This will be particularly relevant for a multi-lane highway.) The image will clearly confirm the relative speed of the vehicles ahead. Furthermore, the driver in vehicle 1B will know instantly that the traffic ahead (perhaps 1 or 2 miles ahead) is at a complete standstill and the driver 1B can pursue alternate routes or at least exit from the highway. The driver 1B may choose to inquire about traffic 4 miles ahead to see if the lanes clear. The driver 1B can also see the traffic signs ahead perhaps directing to an alternate route or approaching exits. An example of this screen display is shown in FIG. 1E. The relative orientation or positioning of the respective vehicles is as shown in FIG. 1A.

FIG. 11 illustrates cabin-facing image processing 47. Cabin-facing image processing 47 primarily operates on the principles of face detection 65, which is commonly available on both iOS and Android software development kit (SDK). The output of Face detection 65 is usually a list of bounding boxes 73 each encloses a detected face. The Driver Facing isolation algorithm 66 will determine which bounding box belongs to the driver 74. Facial landmark detection 69 can find the locations of facial outline, eyes, eyebrows, nose, mouth 75. Their relative placement on the face can be used to estimate the head pose 71 or detect emotion 72. The isolated driver's face can be used to identify the driver for authentication 70. For privacy protection, faces 73 could be blurred by the face obfuscation algorithm 67. The faces can be counted to provide a passenger count 68.

Subcomponents of Front-facing image processing 46 is describe below. Bike detection 49, Car detection 50 and People detection 51 can be done with a single YOLO deep neural network.

Bike Detection 49 Detecting the presence of bikes. Each detected bike is enclosed by a bounding box.

Car detection 50 Detecting presence of cars. Each detected car is enclosed by a bounding box.

People detection 51 Detecting presence of people/pedestrians. Each detected person is enclosed by a bounding box.

Lane detection 52 Detecting left lane line and right lane line. Typically, this is done by performing edge detection, finding Hough lines, detect lanes by finding lines with sufficient length pointing towards the vanishing point 83. (See FIG. 9)

Road sign detection 53 Road sign detection 53 is usually done with a deep neural network pre-trained with different road signs. Other implementation may include image comparison based on line and colors by sliding prototype image of the sign over the entire image. Referencing FIG. 10, to help remove false detection, only zones A, B, C, D and E are checked. The exclusion zone is a rectangle centered about the vanishing point 28 with preset width W.

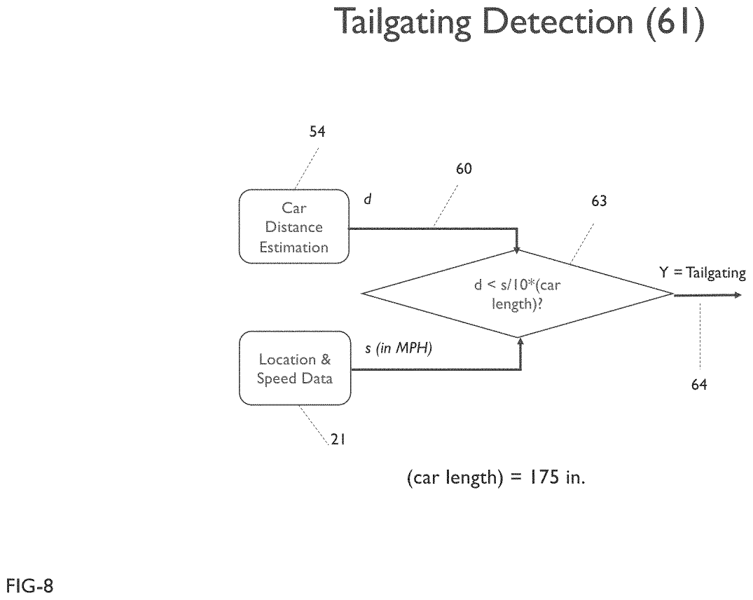

Car detection 50 bounding boxes are used by Car Distance Estimation 54 and Tailgating detection 61 described below. (See FIGS. 7 and 8)

It will be appreciated that the image displayed from the forward camera view can be optionally augmented by the bounding boxes. Therefore the driver receiving the display can have clear notice of objects such as pedestrians, bicycles, street signs and other vehicles. This will facilitate the recognition of these objects. The driver receiving the display will be alerted to these objects. See FIG. 1E

FIG. 7, Car Distance Estimation 54 The bounding boxes 56 from the car detector 50 can be used to estimate the distance to the car in front of the front facing camera. The basic premise is knowing the camera's focal distance f, usually a known camera parameter, and that the average car width is 72 inches, a known constant. Using similar-triangle law (also sometimes termed congruent triangles), the distance d_{c} can be found by d_{c}=x_{c}f/p_{c}, where x_{c} is 72 inches, and p_{c} is the pixel width of the car's bounding box. It will be appreciated that the above expression is derived from the tangential relationship that P_{c}/f =x_{c}/d for similar triangles.

Tailgating detection 61 With the estimated distance to the car in front 60, it is now possible to detect tailgating. A rule of thumb is for adequate car separation is one car length for every 10 miles per hour (MPH). Average car length is175 inches. So, if s is the speed from location & speed data 21 expressed in MPH, then 63 expresses the minimum separation distance that should be tested to determine if tailgating condition 64 exists. If the calculated distance between the participating vehicle is less that the minimum distance computed wherein d_{distance}<S_{speed}/10_{car lengths}×173 inches, the vehicle is tailgating. See FIG. 8. This may result in a signal to the driver of the vehicle.

It will be appreciated that the bounding boxes discussed above appear distinctly within the image received on a second driver's visual display. Traffic signs, vehicle speeds and distances, pedestrians and cycles are therefore highlighted for easy detection by the driver. The visual display supplements and clarifies the view of both the transmitting driver and the image receiving driver. For example, the artificial intelligence algorithm of this disclosure may instantly identify a stop sign before the driver can visually identify the sign by looking through the windshield.

It will be further appreciated that the disclosure may issue a verbal alert to the driver such as “stop sign ahead”, “stop sign in 1000 yards”, “bicyclist on left in 200 yards”, “vehicle 100 yards ahead on left weaving outside traffic lane”, “traffic approaching on right”, etc. This verbal alert will minimize the instances of the driver looking at the display causing distraction.

Lane detection 52 line descriptors 57 are used by lane departure detection 76 (FIG. 9) described below. These descriptors may provide the alert to the driver as discussed in the proceeding paragraph.

Lane departure detection 76 of the participating vehicle can be accomplished by finding the pixel distance between the intersection of a center line 84 (defined by point C from View Port Setup 116, and the focal plane, and points P_{L} and P_{R}, which are interactions of the lane center line 84, the left lane line 85 and the right lane line 86 with the bottom edge of the cropped frame 81 respectively. The pixel distance between C and P_{L} is defined as x_{L}; and the pixel distance between C and P_{R} is x_{R}. A lower threshold can be set for x_{L} and x_{R} to indicate lane departure condition. If the participating vehicle is in the center of the lane, then x_{L}=x_{R} and x_{L}/x_{R}=1. Vehicle movement to the left or right will change the value of x_{L}/x_{R}. If the ratio of the x_{L} and x_{R} exceeds preset parameters, a signal may be communicated. Also if the value of x_{L} or x_{R} falls below a preset value, a signal may also be communicated. The communication may be via a sound or upon the display (or both).

FIG. 10 illustrates road sign detection 53 outputs road sign descriptors 77 which are used by failed-to-stop detection 78 described below with reference to FIG. 6.

If the detected road sign 77 is a stop sign, then location and speed data 21 can be monitored to determine if the driver 1 failed to stop at the stop sign.

Referencing FIG. 11, cabin facing image process 47 top-level components are described below:

Face detection 65 can utilize a still image using iOS or Android built-in functions. In iOS, such function is available in the Vision Framework. In Android, such function is available in Google API under vision.face library. DLIB is another open-source library that can be used.

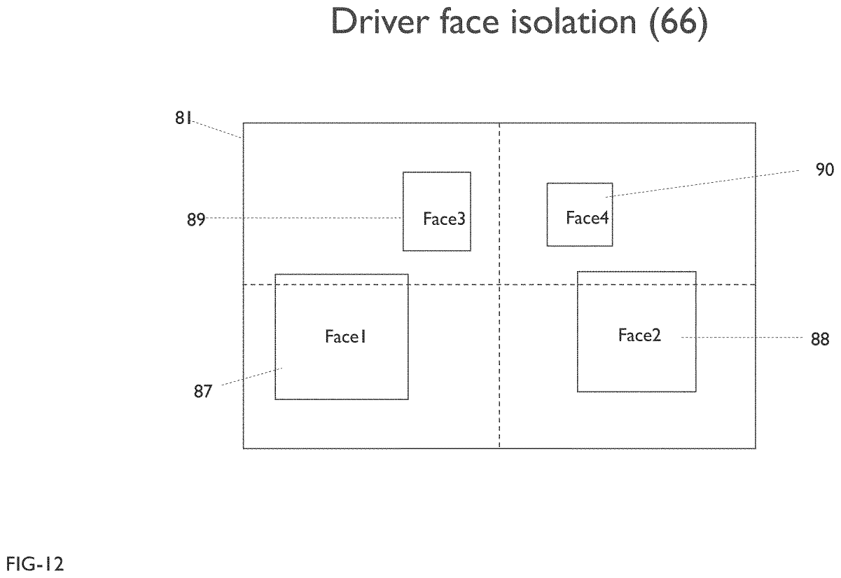

FIG. 12, driver face isolation 66 The driver's face can be isolated through some heuristic. In countries where driver side is on the left, the lowest right bounding box is the driver. In this case, that would be face 2 88. In countries where driver side is on the right, the lowest left bounding box is the driver. In the example given, that would be face 1 87. See FIG. 12.

Face obfuscation 67 If privacy is desired, all faces can be obfuscated by blurring or pixilation, both are common image operations on Android or iOS.

Passenger counting 68 Passenger counting is a byproduct of Driver face isolation 66. The number of face bounding boxes minus the driver identified are considered passengers. If no driver face can be isolated, then everyone in the car are considered passengers.

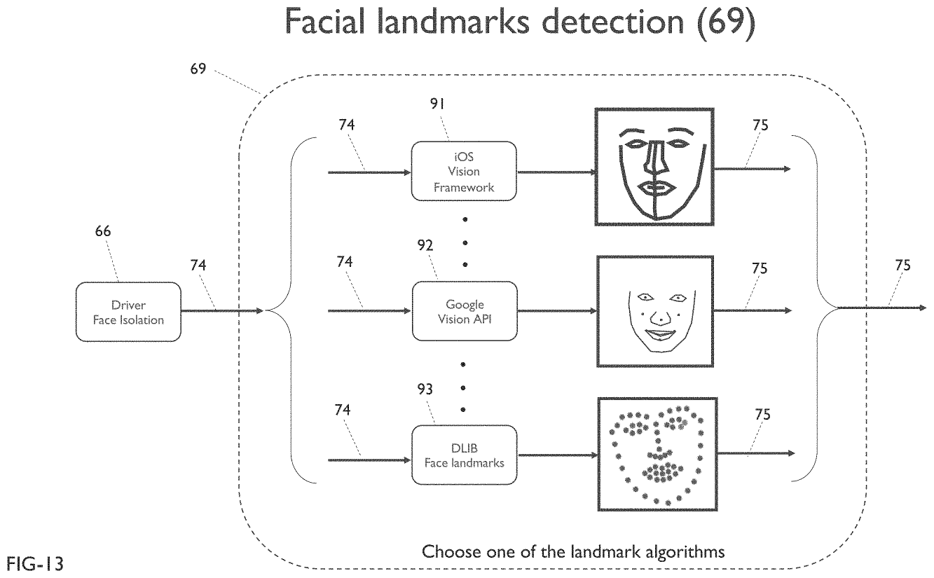

FIG. 13, Facial Landmark Detection 69 can be found in a face image using iOS

Vision Framework 91 or Google Vision API 92, or DLIB face landmarks API 93, or others. These subroutines take as input isolated facial images 74, usually coming from the Driver face isolation 66, and find landmarks 75 in each. It is worth noting that these three API don't produce the same number of landmark points.

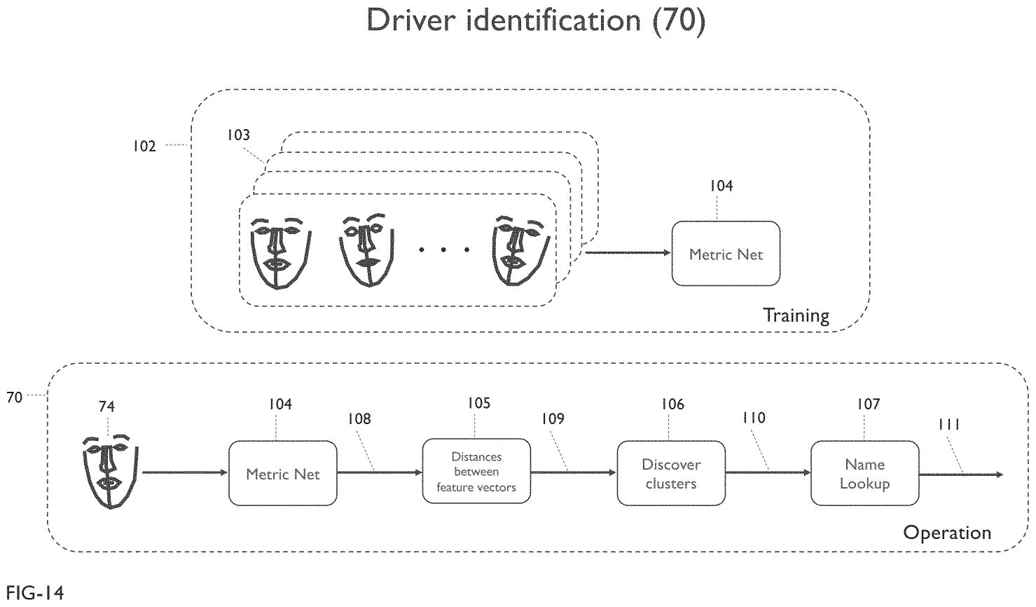

FIG. 14 Isolated driver face 74 can be used to authenticate the driver 70. Driver face can be learned through use of machine learning by training a neural network 102, such as Metric Net 104, by using a training data set of faces of known identities 103. Other driver identification algorithms could be used. Trained network can be used in operation 70 by providing the driver's face image 74 as input. The neural network 104 will detect a set of equalized feature vectors 108. The distance between each pair of feature vector computed 105 and passed onto 109 cluster discovery 106. Discovered clusters, each representing a set of similar images, are labeled 110, and used to lookup name of the person 107. This entire operation ends with the name of the identified person as output 111.

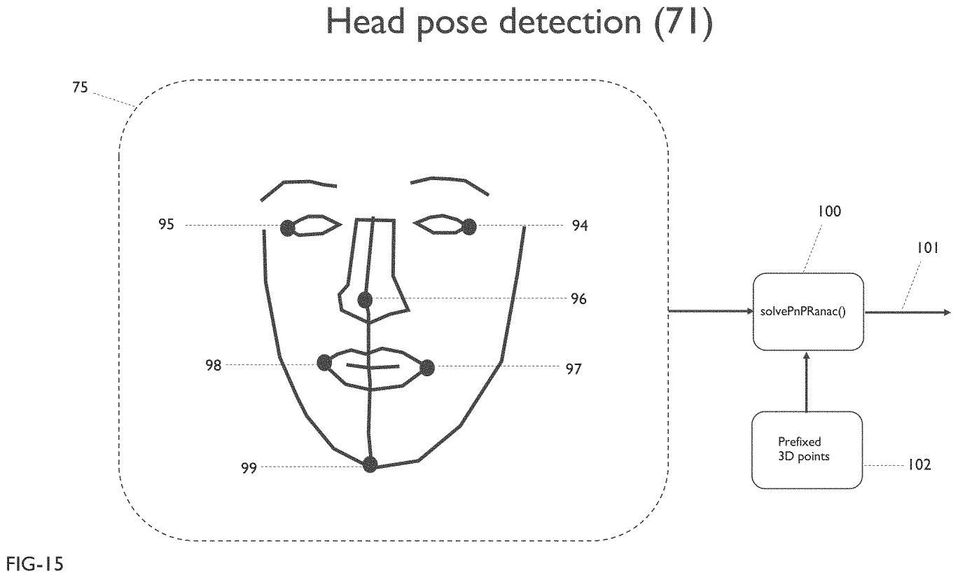

FIG. 15 head pose detection 71 estimates the head orientation based on the facial landmarks 75. Minimum facial landmark required are left eye outside corner 94, right eye outside corner 95, nose 96, left mouth corner 97, right mouth corner 98, and chin 99. These 2D points, along with their prefixed 3D points 102, are used to compute the head pose vector 101. The 3D points 102 are fixed 3D coordinates of all points relative to the nose, which is the origin (0,0,0).

Emotion detection is used to detect emotions such as happy or angry or neutral. Ability to detect emotions can be useful to detect quarrels inside the vehicle to anticipate danger. Emotion detection mostly works by associating the relative positions of the facial landmark features 75 (see FIG. 13) to emotions using a deep neural network (DNN) or a support vector machine (SVM) network.

In an embodiment, a remote observer may monitor the image and data from the driver's vehicle routed from the server or a peer-to-peer communication channel in real time. This image and data may pertain to driver behavior, passenger behavior or vehicle operation such as speed, lane changes or lane compliance, tailgating, etc. The disclosure can include a communication link or component allowing the monitoring observer to communicate to the driver in real time.

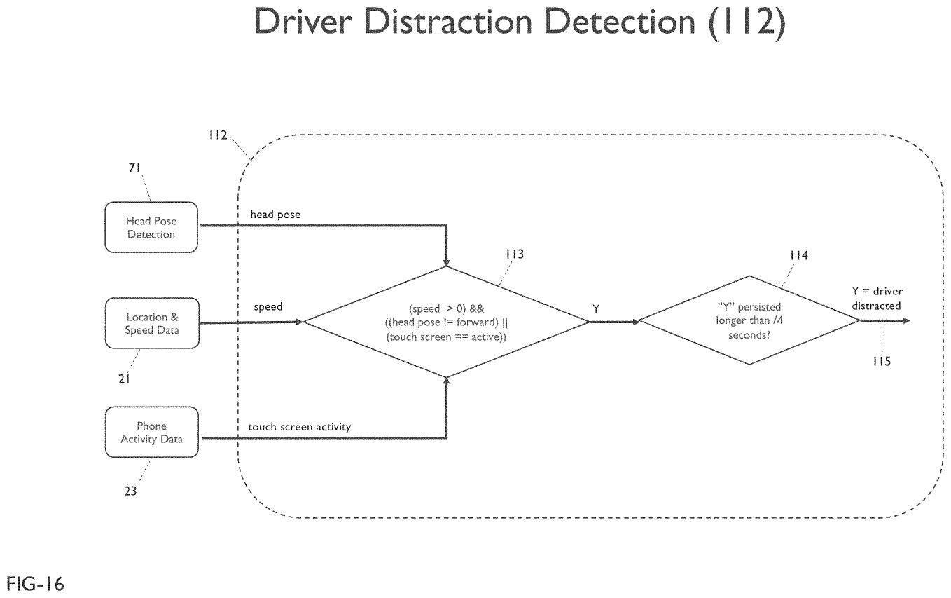

FIG. 16 Driver distraction 112 can be detected utilizing the described algorithm by examining three indicators: driver head pose 71, phone activity 23, and speed 21. An additional indicator may be eye direction. These factors are processed to determine whether sufficient pre-condition 113 exists; and if it is sustained for long enough period of time 114. If both 113 and 114 are true, then distracted driving conditions 115 is indicated.

The calibration subsystem 127 components are described below in FIG. 17, View Port Setup 116. Before the client app 2 can operate properly, view port 81 must be setup or automatically calibrated. Only the image inside the view port is cropped and used in image process. The view port 81 maintains the display aspect ratio as in a mobile phone in landscape mode 79. That same aspect ratio is maintained when the phone is in portrait mode 80. In landscape mode 79, driver 1 is required to adjust a camera mount (not shown) or drag the view port 81 up or down to line up halfway line 82 to the actual horizon. In both portrait mode and landscape mode, the vanishing point marker 83 can be dragged left or right along the horizon. Alternatively, automatic calibration of the vanishing point 83 can be performed. See FIGS. 22-24.

In one embodiment, recording and uploading of driving video is accomplished in the following manner: (1) the driver mounts the smartphone to the vehicle dash such that the display screen is visible to the driver and the camera lens points over the hood of the vehicle creating a road view; (2) the app 2 display is activated and the camera position is adjusted to the horizon and centered in accordance with the procedures illustrated in FIG. 17, View Port Setup, a step that can be skipped if the smartphone is positioned the same way as when it was first calibrated; (3) the smartphone communication subsystem is connected 116 in accordance with FIG. 18; (4) the Image Subsystem 126 is activated in accordance with FIG. 4; (5) the front facing camera 19 is activated (thereby de-activating the cabin-facing camera 20 via switch 28; (6) the microphone 29, deactivated by default, can be re-activated; (7) video streaming 31 is commenced and uploaded via wireless communication 5 to the operator cloud infrastructure 3 (see FIG. 1). While the driver is driving, data frame 18 is sent to operator cloud infrastructure 3 periodically, typically 1Hz.

In another embodiment, client app 2 will periodically alternate 28 between front-facing camera 19 and cabin-facing camera 20 as input the imaging subsystem 126. It will be appreciated that this function can be controlled by adjustment of privacy settings.

In another embodiment, videos from the camera are loop recorded 32 in the smartphone's local storage. This step is illustrated in FIG. 4, Image Subsystem. This loop recording continue to store new video clips until the pre-allocated storage is full, at which point oldest recording is overwritten by new recordings. Recorded files can be requested by a participant driver or other entity via wireless communication 5, 6. See FIG. 1. It will be appreciated that the loop recording contained in the smartphone local storage can be uploaded to operator server/cloud 3 and subsequently shared with other drivers.

In another embodiment, a participant driver, i.e., a driver in a motor vehicle traveling and wanting information regarding traffic conditions ahead, may have a smartphone or similar device mounted on the vehicle dashboard wherein a display is visible to the participant driver. The participant driver can activate the app 2. To request information, the driver may enter location data. For example, the driver could enter “Shephard @ Richmond”. That would provide driver views downloaded from the cloud showing the intersection of Shepard St. and Richmond Ave. Alternatively, the participant driver could enter “northbound Shephard @ richmond”. That request would download more specific videos showing the northbound traffic on Shephard at the intersection with Richmond.

In another embodiment, the participant driver could issue a voice command to the device stating “Northbound at Shephard and Richmond”. That verbal request would respond with relevant real time video. In another embodiment, the disclosure would search loop recordings of participating drivers that have recently traveled through the specified intersection and display that video to the driver. The loop view display could be time stamped. In another embodiment, the disclosure may display a still image to the driver. Reference is made to FIGS. 4 and 20.

In yet another embodiment, the participant driver could activate the built-in GPS mapping feature in the client app 2. The participant driver could receive video images of actual traffic conditions by touching the GPS map screen showing the location of interest. The application of this disclosure could then be insert/display real time video of the location touched on the GPS map display.

As part of the preceding described embodiment, a front facing still image 44 grabbed from the video stream is processed by the Still Image Processing block 34 to detect different events 35. Detected events 42 are updated in the data frame 18 and reported to the operator cloud infrastructure 3. The detected events may initiate a request from a participant driver to view the live streaming video 31.

If a participant driver wishes to see other driver video images, he/she can select the driver from the map view. The selection will cause the client app 2 to send a request to the operator cloud 3, which in turns sends a Get Video 121 request to the selected driver to retrieve the video clip. See FIG. 20.

Communication can also be directed to the driver 1 via wireless communication 7. If one driver wishes to talk to another driver, one can initiate Video Chat Dialing protocol 122; when conversations ends, hang up with Video Chat Hang-up protocol 123. See FIG. 21.

Whenever data is requested, points are spent by the data requester, and awarded to the data provider.

One can earn points by producing or selling data. One can also buy points with money or cryptocurrency.

The client app 2 can be implemented using iOS SDK or Android SDK, together with algorithm components described herein. The operator cloud infrastructure 3 can be leased virtual server and storage on Amazon Web Services (AWS), Microsoft Azure or other open cloud platforms, or a private server farm, or a combination of both. The client app 2 can run any modern smartphones running iOS or Android, and equipped with the required sensors.

The necessary top-level elements are drivers 1 smartphones running the client app 2 and operator cloud infrastructure 3. It will be appreciated that the disclosure also benefits from a plurality of users that can be initiated utilizing crowd sourcing techniques.

Other embodiments of the disclosure can utilize the following components:

(1) OBD data 17 and Vehicle Status 25; (2) Proximity sensor 16 and Proximity data 24; (3) Multi-touch sensor 15 and phone activity data 23 (4) G-sensors 14 and Acceleration data 22 (5) video streaming 31—if excluded, cannot do video chat; (6) bike detection 49 and people detection 50; (7) Lane detection 52—if excluded, cannot do lane departure warning 76; (8) Road sign detection 53; (9) cabin-facing image processing 47; (10) face obfuscation 67; (11) driver identification 70; Video chat part of the communication 124; and (12) control of smartphone by voice commands

While smartphones are the perhaps most ubiquitous means to collect driver data, since almost everyone has a smart phone, it can be replaced with other devices, including a dash camera, an embedded camera, or 2D/3D sensor system such a LiDAR or Time of Flight sensors. The display screens for smart phone vary from approximately 5 to 6.5 inches in width. Pixels per inch (PPI) varies from approximately 350 to 460. Tablet computer display screen widths can vary between 10 and 12.5 inches. It will be appreciated that a larger display screen may enhance the display of information transmitted and processed by the algorithms of this disclosure with minimal distraction to the driver. The dash mounted display will minimize the amount the driver will need to divert his vision from the actual road view (via through the windshield) and the display. This may be superior to affixing the display to the vehicle instrument panel.

The disclosed invention could be used among a group of affiliated drivers for purpose of fleet management and asset tracking, or tracking of family members. The insurance companies may deploy all or parts of the invention to collect driver behavior data to model driving risk so more accurate insurance premium can be assessed.

In an additional embodiment, the disclosure can be combined with functional tools available in commercial GPS mapping applications such as Mapbox®, Google Map or Waze®. This combined application could allow a driver to utilize one enhanced system without need of shifting from one application to another. Waze is the registered trademark of Google LLC. Mapbox is the registered trademark of Mapbox, Inc. This may facilitate alternate route planning to be selected by a driver in view of traffic conditions disclosed by the display.

If one desires to see current images or videos from other drivers, do the following:
1. Switch to the map view to see the driver current location as well as other drivers available. These locations are shown as moving icons on the map. The map can be panned to other locations.
2. Select any driver available and a pop-up window shall display the video/image from that driver.
3. Similarly, through the map one will be able to retrieve images/video for a selected location from the local video loop recording 32, or from those previously uploaded to operator cloud infrastructure 3.

If the driver desires to see current account credit balance from data sales, do the following:
1. Switch to profile view and select account management; the account balance and transaction history will be displayed.
2. In one embodiment, if points earned from selling data can be converted to cash, then driver may convert the points to money and wire the fund to his or her bank account.

If driver desires to buy from operator's 3 online shop, then the driver can do the following:
1. Navigate to the shop page
2. Make the purchase

If the driver needs services, driver may do the following:
1. Navigate to services page
2. Select from the offered services

Driver can change the client app 2 settings by:
1. Navigate to settings page
2. Select the settings to change (options may include but are not limited to Alert notification, data usage/privacy, payment, support and report a problem)
3. Settings is also where user can sign out. Other sign out option may be used.

It will be appreciated that the teachings of this disclosure have many applications. These applications include, but are not limited to:

Look ahead in a congested traffic, e.g., widely deployed client app will enable on select a desired location along any route and get a near real time image and video of the scene.

EMS accident assessment which may allow emergency service such as ambulance, firefighters and police to get a first look at the scene before actually arriving.

Amber and Silver alert wherein widely deployed client app gives the ability to quickly find abducted child or lost elderly by reading their license plate.

Safe driver's education wherein driving instructor can provide remote instruction through the phone using the video chat feature.

Other applications include (i) tracking loved ones and family member, employees, etc., (ii) assessing driver risk based upon observed behavior, (iii) report traffic accidents or other news items, e.g., traffic reports for news outlets, (iv) updating maps, etc.

Essential elements of the client app 2 could be encapsulated as software development kit (SDK), enabling others to embed the SDK inside their own app. Similarly, the software running on the operator cloud infrastructure 3 could be converted into an SDK so licensees could duplicate it on their own cloud infrastructure.

This specification and accompanying drawings are to be construed as illustrative only and is for the purpose of teaching those skilled in the art the manner of carrying out the disclosure. It is to be understood that the forms of the disclosure herein shown and described are to be taken as the presently preferred embodiments. As already stated, various changes may be made in the shape, size and arrangement of components or adjustments made in the steps of the method without departing from the scope of this disclosure. For example, equivalent elements may be substituted for those illustrated and described herein and certain features of the disclosure maybe utilized independently of the use of other features, all as would be apparent to one skilled in the art after having the benefit of this description of the disclosure.

While specific embodiments have been illustrated and described, numerous modifications are possible without departing from the spirit of the disclosure, and the scope of protection is only limited by the scope of the accompanying claims.

What we claim is:

1. A vehicle driver and passenger monitoring system comprising:
(a) a camera recording the image of a vehicle interior wherein the camera records an image of a driver;
(b) a transmission component for uploading live or recorded camera images to a remote server;
(c) a facial recognition component capable of assessing identity, eye direction, attention, mood or emotions of the driver.

2. The driver and passenger monitoring system of claim 1 further comprising recording and uploading OBD information to the remote server of vehicle operation including but not limited to vehicle speed, acceleration, braking or turning.

3. The driver and passenger monitoring system of claim 1 further comprising the camera records the image of one or more passengers.

4. The driver and passenger monitoring system of claim 1 further wherein the image of the driver is monitored in real time.

5. The driver and passenger monitoring system of claim 4 further comprising a communication component allowing communication between the remote server and the driver.

6. The driver and passenger monitoring system of claim 1 wherein the camera is a smart phone or tablet.

7. A driver safety assessment method comprising:
(a) using a camera to record forward road condition and monitor driver head position and eye direction during vehicle operation; and
(b) using simultaneous monitoring of vehicle operation including variables such as speed, acceleration, braking and turning.

8. The driver safety assessment method of claim 7 wherein the monitoring of vehicle operation utilizes a smart phone or tablet.

9. The driver safety assessment method of claim 7 wherein the monitoring of vehicle operation utilizes vehicle OBD components.

10. The driver safety assessment method of claim 7 further comprising uploading the recorded image and data to a remote server.

11. The driver safety assessment method of claim 10 wherein the uploading occurs in real time.

12. A driver safety assessment method comprising:
(a) assessing driver distraction using a camera to record driver head position and eye direction during vehicle operation; and
(b) monitoring information of driver head position or eye direction at a remote location.

13. The driver safety assessment method of claim 12 further comprising monitoring one or more of variables including vehicle speed, acceleration, braking or turning.

14. The driver safety assessment method of claim 12 further comprising monitoring the information in real time.

15. The driver safety assessment method of claim 12 further comprising
(a) mapping driver facial landmarks; and
(b) using a DNN or SVM network to recognize emotions from driver facial landmarks.

16. The driver safety assessment method of claim 13 further comprising using a communication component to allow the remote server location to communicate to the driver in real time.

17. The driver distraction assessment method of claim 13 further comprising isolating and locating the driver's face in the image recorded by the camera.

18. The driver distraction assessment method of claim 13 further comprising obscuring passenger faces from the image recorded by the camera for privacy and anonymity.
